(19) United States
(12) Patent Application Publication
(10) Pub. No.: US 2026/0316729 A1
(43) Pub. Date: Oct. 15, 2026

(54) METHOD AND CONTROL DEVICE FOR OPERATING A MOTORCYCLE HAVING AN ELECTRONIC COMBINED BRAKE SYSTEM

(71) Applicant: Robert Bosch GmbH, Stuttgart (DE)

(72) Inventors: Bernhard Paulus, Deckenpfronn (DE); Florian Bauer, Schwieberdingen (DE)

(21) Appl. No.: 19/483,309

(22) PCT Filed: May 7, 2024
(86) PCT No.: PCT/EP2024/062621

§ 371 Date: Dec. 5, 2025

(30) Foreign Application Priority Data
May 22, 2023 (DE) 10 2023 204 738.1

(51) Int. Cl. B60T 8/26; B60T 7/12; B60T 8/17; B60T 8/171; B60T 8/1755; B60T 8/24

(52) U.S. Cl. CPC B60T 8/261; B60T 7/12; B60T 8/1706; B60T 8/171; B60T 8/17551; B60T 8/17552; B60T 8/17554; B60T 8/241; B60T 2220/04; B60T 2230/02

(57) ABSTRACT

A method for operating a motorcycle having an electronic combined brake system (eCBS). A braking force is generated on a rear wheel of the motorcycle using the eCBS when a front wheel brake of the motorcycle is actuated by a driver of the motorcycle. The braking force on the rear wheel is dynamically controlled using the eCBS depending on a current driving situation of the motorcycle.

### FIELD

The present invention relates to a method for operating a motorcycle having an electronic combined brake system, to a corresponding control device, and to a corresponding computer program product.

### BACKGROUND INFORMATION

A motorcycle can comprise an integral brake. Due to the integral brake, a rear wheel brake of the motorcycle is also actuated when the driver actuates a front wheel brake of the motorcycle via a brake lever on the handlebar. As a result, actuating the brake pedal for the rear wheel brake is not required.

If the rear wheel loses grip on the ground, the ABS of the motorcycle can bring the rear wheel back into the range of static friction by cyclically reducing and rebuilding brake pressure in the rear wheel brake. This prevents the rear wheel from breaking loose.

Europe Patent No. EP 1 754 640 B1 describes an integral brake system.

### SUMMARY

The present invention provides a method for operating a motorcycle having an electronic combined brake system, a corresponding control device, and also a corresponding computer program product. Advantageous developments and improvements of embodiments of the present invention are disclosed herein.

According to an example embodiment of the present invention, the braking force on the rear wheel is not cyclically and abruptly reduced and then rebuilt as in an anti-lock brake system, but is dynamically controlled depending on the driving situation. Depending on the driving situation, varying amounts of braking force on the rear wheel can be transmitted to the ground. The driving situation is recognized and the braking force that can be transmitted is determined. The dynamic control makes it possible to keep the braking force on the rear wheel as constant and as high as possible. The braking force on the rear wheel is therefore not in a fixed ratio to a braking force on the front wheel. Due to the dynamic control, the braking force on the rear wheel can be varied when there is a constant total braking demand. In particular, due to the control, the distribution of braking force of the total braking demand between the front wheel and the rear wheel can be varied.

Due to the approach presented here according to an example embodiment of the present invention, the rear wheel can be operated permanently within a static friction range in different driving situations. A certain amount of slippage can be allowed, since a maximum transmissible force is only reached when the wheel exhibits slippage. The braking force is controlled so that the slippage is less than the slippage at the maximum of the transmissible force. If this maximum were exceeded, the rear wheel would enter the sliding friction range and slip away. If the rear wheel enters the sliding friction range despite the dynamic control, the ABS can intervene and abruptly and significantly reduce the braking force in order to accelerate the rear wheel again and bring it back into the static friction range. However, the braking force is dynamically controlled so that the rear wheel remains in the static friction range almost at all times. Due to this control, the need for ABS intervention is eliminated.

According to an example embodiment of the present invention, a method for operating a motorcycle having an electronic combined brake system (eCBS) is provided, wherein a braking force is generated on a rear wheel of the motorcycle using the eCBS when a front wheel brake of the motorcycle is actuated by a driver of the motorcycle, wherein the braking force on the rear wheel is dynamically controlled using the eCBS depending on a current driving situation of the motorcycle.

Ideas for embodiments of the present invention may be considered, inter alia, as being based on the concepts and findings described below.

An electronic combined brake system can be abbreviated as eCBS. The eCBS can be operated via a central operating element. The central operating element on a motorcycle is a brake lever on the handlebar of the motorcycle. When the central control element is actuated, both a front wheel and a rear wheel of the motorcycle are braked. Actuating a brake pedal to brake the rear wheel is not required.

A driving situation can be, for example, straight-ahead travel, initiating a turn or cornering. The driving situation can be recognized using sensor data from the motorcycle. Depending on the driving situation, varying amounts of braking force on the rear wheel can be transmitted.

The current driving situation can be recognized using a lean angle of the motorcycle. Due to the lean angle, for example, cornering can be distinguished from straight-ahead travel. During cornering, lateral guiding forces are transmitted to the ground. The lateral guiding forces reduce a transmissible braking force.

The current driving situation can be recognized using a slip angle of the rear wheel. A slip angle can result from a superposition of longitudinal rolling of the rear wheel and slippage in the transverse direction. Slippage in the transverse direction can be caused by the lateral guiding forces during cornering. Due to the slip angle, different types of cornering maneuvers can be distinguished.

The braking force on the rear wheel can be set using at least one predefined brake pressure ramp. A brake pressure ramp can specify a rate of change of the braking force. Due to the brake pressure ramp, an abrupt change in braking force can be prevented. Due to the brake pressure ramp, a jolt at the rear wheel can be prevented. The brake pressure ramp can ensure a gradual change in braking force.

According to an example embodiment of the present invention, in response to recognizing cornering as the driving situation, the braking force on the rear wheel can be maintained at least in part up to or shortly after an apex of the cornering maneuver, until an end of the cornering maneuver is recognized and/or until an acceleration request is recognized. After passing the apex of the cornering maneuver, braking, in particular slight braking, can continue to be applied at the rear wheel in order to stabilize the motorcycle when exiting the corner. Due to the braking of the rear wheel, the motorcycle can be straightened. Due to the braking of the rear wheel, the directional stability of the motorcycle while cornering can be increased. The end of the cornering maneuver can be recognized when an acceleration request is detected via a throttle grip of the motorcycle. When the motorcycle accelerates out of the curve again, the brake on the rear wheel can be released.

The apex can be recognized using the lean angle. In particular, a progression of the lean angle can be monitored. The lean angle can exhibit a maximum at the apex.

Alternatively or additionally, the apex can be recognized when the front wheel brake is released. When cornering in a sporty manner, the driver will brake until the apex and accelerate shortly after the apex. The rear wheel can continue to be braked, in particular slightly, after the front wheel brake is released and until acceleration begins.

According to an example embodiment of the present invention, in order to reduce the braking force on the rear wheel, an adjustable proportional valve of the eCBS can be used. A proportional valve can assume intermediate positions between an open position and a closed position. The proportional valve can be an extra valve in a brake system of the motorcycle. The proportional valve cannot be part of the ABS. Due to the proportional valve, the rate of pressure reduction of a brake pressure in a brake circuit of the rear wheel can be set. Due to the proportional valve, an abrupt drop in brake pressure, such as that caused by opening an ABS outlet valve, is prevented. In order to increase the braking force, an adjustable pump of the brake system and/or another proportional valve of the eCBS can be used.

The braking force on the rear wheel can be increased independently of the driving situation when the braking force is generated via a brake pedal on the motorcycle. The dynamic control of the braking force can be overridden using the brake pedal. Since the dynamic control of the braking force presented here sets the braking force close to the possible maximum, the rear wheel can be brought into the sliding friction range by braking on the brake pedal. The rear wheel can also be locked.

The braking force on the rear wheel can be dynamically controlled depending on the driving situation, independently of any actuation of the front wheel brake. The rear wheel brake can be actuated, for example, to stabilize the motorcycle.

The method of the present invention is preferably computer-implemented and can be implemented, for example, in software or hardware or in a mixed form of software and hardware, for example in a driver assistance system.

The approach presented here according to the present invention furthermore provides a control device, wherein the control device is designed to carry out, control, or implement, in corresponding apparatuses, the steps of a variant of the method of the present invention presented here.

The control device can be an electrical device comprising at least one computing unit for processing signals or data, at least one memory unit for storing signals or data, and at least one interface and/or one communication interface for reading in or outputting data embedded in a communication protocol. The computing unit can, for example, be a signal processor, a so-called system ASIC, or a microcontroller for processing sensor signals and outputting data signals depending on the sensor signals. The memory unit can, for example, be a flash memory, an EPROM, or a magnetic memory unit. The interface can be designed as a sensor interface for reading in the sensor signals from a sensor and/or as an actuator interface for outputting the data signals and/or control signals to an actuator. The communication interface can be designed to read in or output the data in a wireless and/or wired manner. The interfaces may also be software modules that are present, for example, on a microcontroller in addition to other software modules.

A computer program product or a computer program, which has program code that can be stored on a machine-readable carrier or storage medium, such as a semiconductor memory, a hard disk memory, or an optical memory, and that is used for carrying out, implementing, and/or controlling the steps of the method according to one of the embodiments of the present invention described above, in particular when the program product or program is executed on a computer or an apparatus, is advantageous as well.

It is pointed out that some of the possible features and advantages of the present invention are described herein with reference to different embodiments. A person skilled in the art recognizes that the features of the control device and of the method can be suitably combined, adapted or replaced in order to arrive at further embodiments of the present invention, in view of the disclosure herein.

### BRIEF DESCRIPTION OF THE DRAWING

Embodiments of the present invention are described below with reference to the figure, and neither the figure nor the description should be construed as limiting the present invention.

FIG. 1 is a representation of a motorcycle having a control device according to an exemplary embodiment of the present invention.

The figure is merely schematic and not true to scale. Identical reference signs denote identical or identically acting features.

### DETAILED DESCRIPTION OF EXAMPLE EMBODIMENTS

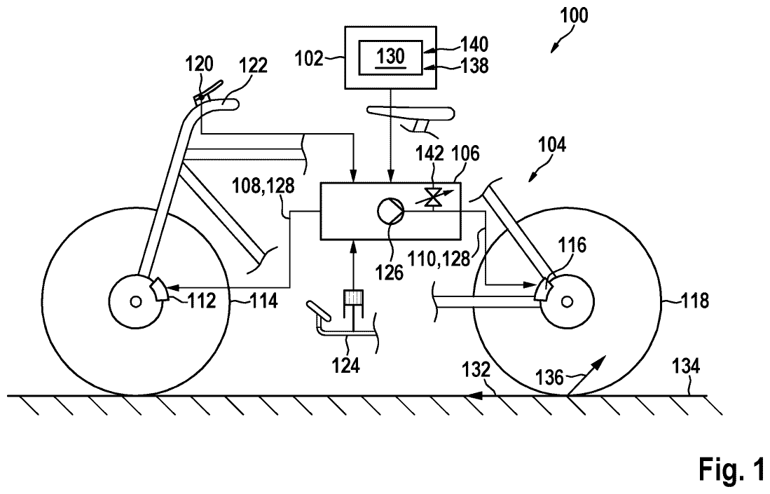

FIG. 1 is a representation of a motorcycle 100 having a control device 102 for actuating a dynamic electronic combined brake system 104 of the motorcycle 100. The dynamic electronic combined brake system 104 is abbreviated as Dynamic eCBS 104. The Dynamic eCBS 104 features a pump and valve block 106 with a front brake circuit 108 and a rear brake circuit 110. The front brake circuit 108 acts on a front wheel brake 112 on a front wheel 114 of the motorcycle 100. The rear brake circuit 110 acts on a rear wheel brake 116 on a rear wheel 118 of the motorcycle 100. Each of the brake circuits 108, 110 comprises a master brake cylinder. The master brake cylinder of the front brake circuit 108 is arranged on a brake lever 120 on a handlebar 122 of the motorcycle 100. The master brake cylinder of the rear brake circuit 110 is arranged on a brake pedal 124 of the motorcycle 100.

A hydraulic pump 126 is integrated into the pump and valve block 106. The hydraulic pump 126 can increase a brake pressure 128 in the front brake circuit 108 and/or in the rear brake circuit 110 via a pressure requested at the particular master brake cylinder.

Due to the Dynamic eCBS 104, brake pressure 128 is generated in the rear brake circuit 110 using the hydraulic pump 126 when brake pressure 128 is generated in the front brake circuit 108 via the brake lever 120. As a result, no actuation of the brake pedal 124 is required to brake the rear wheel 118, and both the front wheel 114 and the rear wheel 118 are braked when the brake lever 120 is actuated.

In the approach presented here, the brake pressure 128 in the rear brake circuit 110 is dynamically controlled depending on a current driving situation 130. The current driving situation 130 determines how much braking force 132 can be transmitted directly from the rear wheel 118 to the ground 134. The Dynamic eCBS 104 controls the braking force 132 so that approximately a maximum of the instantaneously possible braking force 132 is transmitted. The braking force 132 is set as constant and as high as possible.

In terms of the driving situation 130, a distinction is made in particular between straight-ahead travel and cornering. During cornering, less braking force 132 can be transmitted to the ground 134 than during straight-ahead travel, since a lateral guiding force 136 is also transmitted to the ground 134 and the grip of the rear wheel 118 on the ground 134 is limited.

In one exemplary embodiment, the driving situation 130 is recognized using an instantaneous lean angle 138 of the motorcycle 100. Due to the lean angle 138, straight-ahead travel can be distinguished from cornering.

In one exemplary embodiment, the driving situation 130 is recognized using an instantaneous slip angle 140 of the rear Wheel 118. Due to the slip angle 140, different types of cornering maneuvers can be distinguished.

In one exemplary embodiment, when cornering is detected, the rear wheel 118 continues to be braked at least lightly after the apex of the curve, until the cornering is finished and/or the motorcycle accelerates out of the curve. As a result, the directional stability of the rear wheel 118 when entering the curve up to the apex is increased. The apex can be recognized when the lean angle 138 reaches a maximum. Alternatively or additionally, the apex can be recognized when the brake lever 120 is released.

In one exemplary embodiment, the pump and valve block 106 comprises at least one proportional valve 142 in the rear brake circuit 110. The proportional valve 142 can open to varying degrees, thus controlling the flow through the proportional valve 142. For example, the brake pressure 128 in the rear brake circuit 110 can be slowly reduced via the proportional valve 142 in order to adjust the braking force 132 to the current driving situation 130. The proportional valve 142 is not part of the ABS control system of the motorcycle 100.

In one exemplary embodiment, the Dynamic eCBS 104 can be overridden by pressing the brake pedal 124. By pressing the brake pedal 124, the brake pressure 128 in the rear brake circuit 110 can be increased beyond the pressure that is optimal for the driving situation 130. As a result, the rear wheel 118 is braked more strongly than required for the instantaneous driving situation 130 and can enter the sliding friction range. The rear wheel 118 can be locked at any time via the brake pedal 124.

Some possible embodiments of the present invention are summarized again below or described using slightly different words.

A dynamic electronic combined brake system for motorcycles (Dynamic eCBS) is presented.

A motorcycle having an electronic combined brake system (eCBS) requires a dual-channel ABS hydraulic unit having a pump motor and additional valves in order to make an active pressure build-up possible. Active pressure build-up (integral braking) can take place either in the rear brake circuit or in the front brake circuit. The use of eCBS increases the stability and deceleration of motorcycles.

The presented approach increases the overall safety and performance of the eCBS when driving on the racetrack or off-road.

Sports motorcycles typically have a plurality of ABS modes, one of which is intended exclusively for use on the racetrack and/or off-road. In this special mode, the rear wheel ABS is deactivated in order to give the driver more individual control over the rear wheel. Currently, the use of eCBS having the rear wheel ABS deactivated is highly limited due to the instability that arises from active pressure build-up on the rear wheel during heavy braking, roadway changes or cornering. Alternatively, the eCBS can also be used with active rear wheel ABS in order to achieve safety aspects, but with reduced performance.

The approach presented here uses eCBS, wherein the rear wheel ABS is deactivated from the point of view of the driver, and nevertheless a stable vehicle is still ensured.

The dynamic eCBS on the rear wheel is presented.

In order to ensure a stable vehicle during active pressure build-up at the rear wheel (partial integral braking), Dynamic eCBS monitors the stability of the vehicle. The active pressure built up at the rear wheel is controlled based on stability criteria such as rear wheel slip, rear wheel deceleration, lean angle and/or slip angle, in order to ensure a consistently stable vehicle. In order to ensure this, the Dynamic eCBS is able to control the pressure independently of the braking input of the driver on the front wheel brake.

Dynamic eCBS controls the active brake pressure build-up at the rear wheel in order to achieve maximum performance depending on the driving situation (straight-ahead travel, initiating a turn, cornering). In the event of instability, the Dynamic eCBS can automatically reduce the built-up active pressure until the vehicle is stable again, without the ABS outlet or inlet valve intervening. The rear ABS is not required and remains inactive at all times. The driver can manually lock the rear wheel at any time.

The dynamic eCBS can be used on its own as described above. The dynamic eCBS can also be used in combination with a semi-active rear wheel ABS in order to increase safety.

Due to the use of the Dynamic eCBS, higher performance and stability are achieved compared to a standard eCBS, tailored to the requirements of the racetrack and off-road.

Increased deceleration and braking stability are achieved, since the rear axle brakes automatically. As a result, improved controllability is achieved, since the driver only needs to focus on the front brake.

Dynamic eCBS constantly adjusts the active pressure built up on the rear wheel to the current driving situation. This leads to improved cornering of the motorcycle and helps the driver maintain their lane while braking.

The presented approach can be applied to any vehicle (ABS mode) where the rear ABS is deactivated, the rear ABS is only partially active or the rear ABS is not present.

With the dynamic eCBS, the driver can intentionally lock the rear wheel via the rear brake pedal, and the eCBS (partial integral braking) is available at the rear wheel (eCBS from front to rear), and the dynamic eCBS controls the active pressure that is built up in order to ensure the stability and performance of the vehicle.

Finally, it should be pointed out that terms like “having,” “comprising,” etc. do not exclude other elements or steps and terms like “a” or “an” do not exclude a plurality.

1-13. (canceled)

14. A method for operating a motorcycle which includes an electronic combined brake system (eCBS), the method comprising the following steps:
generating a braking force is generated on a rear wheel of the motorcycle using the eCBS when a front wheel brake of the motorcycle is actuated by a driver of the motorcycle; and
dynamically controlling the braking force on the rear wheel depending on a current driving situation of the motorcycle, using the eCBS.

15. The method according to claim 14, wherein the current driving situation is recognized using a lean angle of the motorcycle.

16. The method according to claim 14, wherein the current driving situation is recognized using a slip angle of the rear wheel.

17. The method according to claim 14, wherein the braking force on the rear wheel is set using at least one predefined brake pressure ramp.

18. The method according to claim 14, wherein, in response to recognizing cornering as the driving situation, the braking force on the rear wheel is maintained at least in part up to or shortly after an apex of a cornering maneuver, until an acceleration request is recognized.

19. The method according to claim 18, wherein the apex is recognized using a lean angle of the motorcycle.

20. The method according to claim 18, wherein the apex is recognized when the front wheel brake is released.

21. The method according to claim 14, wherein an adjustable proportional valve of the eCBS is used to reduce the braking force on the rear wheel.

22. The method according to claim 14, wherein the braking force on the rear wheel is increased independently of the driving situation when the braking force is generated via a brake pedal of the motorcycle.

23. The method according to claim 14, wherein the braking force on the rear wheel is dynamically controlled depending on the driving situation independently of an actuation of the front wheel brake.

24. A device, comprising:
a control device configured to operate a motorcycle which includes an electronic combined brake system (eCBS), the control device configured to perform the following steps including:
generating a braking force is generated on a rear wheel of the motorcycle using the eCBS when a front wheel brake of the motorcycle is actuated by a driver of the motorcycle, and
dynamically controlling the braking force on the rear wheel depending on a current driving situation of the motorcycle, using the eCBS.

25. A non-transitory machine-readable storage medium on which is stored a computer program for operating a motorcycle which includes an electronic combined brake system (eCBS), the computer program, when executed by a processor, causing the processor to perform the following steps comprising:
generating a braking force is generated on a rear wheel of the motorcycle using the eCBS when a front wheel brake of the motorcycle is actuated by a driver of the motorcycle; and
dynamically controlling the braking force on the rear wheel depending on a current driving situation of the motorcycle, using the eCBS.
